(19) United States
(12) Patent Application Publication
(10) Pub. No.: US 2025/0388106 A1
(43) Pub. Date: Dec. 25, 2025

(54) DEVICE WITH POWER SUPPLY THROUGH A CONTACT OF A CHARGING STATION

(71) Applicant: AUDI AG, Ingolstadt (DE)

(72) Inventors: Eike FRAUNHOFER, Reichertshofen (DE); Richard KAUßLER, Schernfeld (DE); Roland TORNAR, Hitzhofen (DE)

(21) Appl. No.: 19/242,741

(22) Filed: Jun. 18, 2025

(30) Foreign Application Priority Data
Jun. 20, 2024 (DE) 102024117379.3

(51) Int. Cl. B60L 53/60; B60L 53/16

(52) U.S. Cl. CPC B60L 53/60; B60L 53/16; B60L 2210/14

(57) ABSTRACT

A device is disclosed which is configured to receive electrical energy from a Control Pilot (CP) contact of a charging station, the device having at least one load that, in operation, is supplied with the energy from the CP contact of the charging station, and a current limiter connected between the CP contact of the charging station and the load. The at least one load, in operation, is supplied with the electrical energy from the charging station in a standby mode of the charging station via the current limiter. Furthermore, an arrangement having a device and a charging station is disclosed.

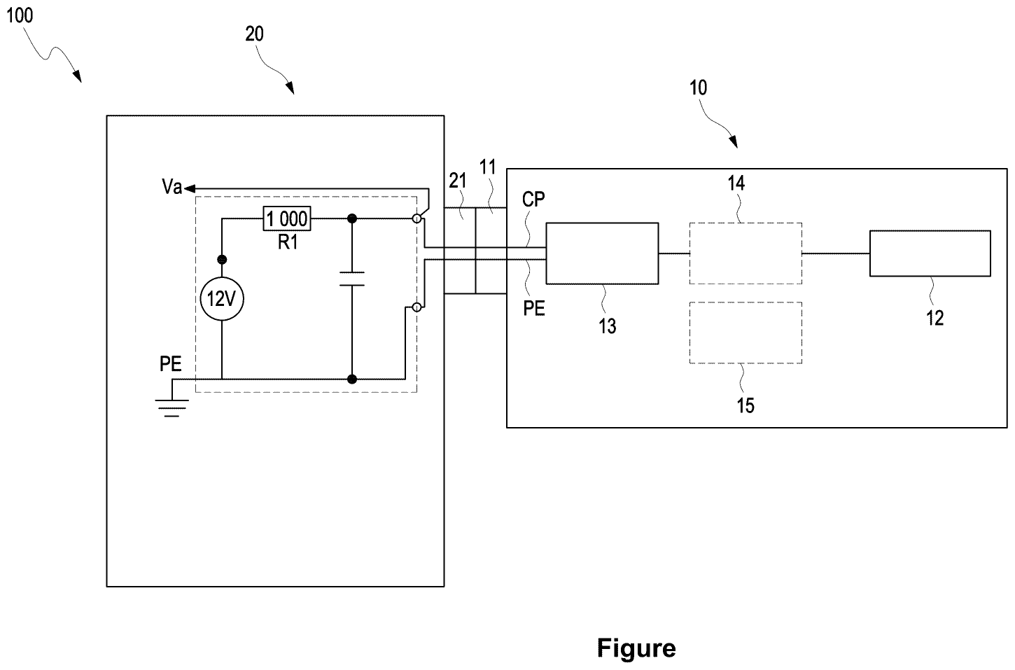

### BACKGROUND

### Technical Field

The disclosure relates to a device which is configured to receive electrical energy from a Control Pilot (CP) contact of a charging station, wherein the device has at least one load that can be supplied with energy from the CP contact. Furthermore, the disclosure relates to an arrangement having a charging station and a device.

### Description of the Related Art

Currently available charging stations, such as, for example, wallboxes, are not set up, in standby mode, to provide energy to power a plugged-in load. Power can only be supplied to a load plugged into the charging station once a charging process has begun. Energy is transferred normally via the charging station's AC output.

As long as no charging process has been started, operation of a connected instrument is only possible if this instrument has an additional external power supply or includes an additional energy storage device.

In standby mode, each charging station supplies a high-impedance 12 V level via its CP (Control Pilot) contact in accordance with the IEC61851-1 standard. The charging station applies a voltage of +12 V to a contact relative to a protective conductor to register the connection of a vehicle. If a vehicle is connected to a charging cable of the charging station, the 12 V level drops, and the charging station exits standby mode. Charging energy can be released via the AC output after exiting standby mode. For example, KR 1020170094869 A describes the basic function of the CP contact in charging stations. This functionality is also described in DE102013226444A1.

JP 2012085458 A describes a charging device that prevents unintentional interruption of a charging process due to a fluctuating potential at the CP contact.

### BRIEF SUMMARY

Embodiments of the present disclosure provide a device and an arrangement by which a power supply to a load is possible in the standby mode of a charging station.

The device according to the disclosure is configured to receive electrical energy from a CP contact of a charging station. The device has at least one load which can be or is to be supplied with energy from the CP contact. For this purpose, the load can be connected to the CP contact and, for example, to a protective conductor of the charging station. According to the disclosure, the device has a current limiter connected between the CP contact and the load.

The device and/or the load are advantageously arranged outside the charging station or are formed externally and can be electrically connected to the charging station directly or to a charging cable of the charging station.

According to a further aspect of the disclosure, an arrangement is provided. The arrangement has a device according to the disclosure and a charging station with at least one charging plug. The charging plug has a CP contact and a protective conductor, wherein the device is connected to the charging device via the CP contact and the protective conductor. The charging plug can have additional connections or outputs, such as, for example, AC outputs.

According to the disclosure, at least one load of the device can be supplied with electrical energy in a standby mode of the charging station by a current limiter of the device.

The at least one load or the device can be designed as a standalone component that can be supplied with electrical energy by the charging station without “waking” it from standby mode or standby operation. Such a load can be electrically connected to any charging station.

The CP contact or CP output of the charging station has a 12 V level, which would dip if a load were directly connected. Using a current limiter reduces the voltage or potential dip at the CP output in such a way that the charging station remains in standby mode. This allows the CP output to be used to continuously supply a component or load with low energy consumption without affecting the operation of the charging station.

According to an exemplary embodiment, the current limiter is configured to limit a current drawn by the CP contact in such a way that a voltage drop of a potential between the CP contact and a protective conductor is less than 3 V. This measure minimizes the voltage dip of the potential provided by the CP contact despite a load being connected, so that the potential remains, for example, above a limit value, in particular above +9 V. This prevents the limit value for exiting the standby mode of the charging station from being exceeded.

According to a further embodiment, the device has a voltage converter or step-up converter which is connected downstream of the current limiter and upstream of the load. This allows the load to be optimally supplied with a voltage provided by the voltage converter or step-up converter. The step-up converter can also generate a voltage higher than 9 V or 12 V. Furthermore, the use of a voltage converter or step-up converter enables the provision of a constant voltage even with a fluctuating potential of the CP contact.

According to a further exemplary embodiment, the device has an electrical storage device in the form of a rechargeable battery and/or in the form of a capacitor. This measure allows an electrical storage device to be charged in addition to the load using the electrical supply via the CP contact, in order to optimally compensate for fluctuations in the energy supply via the CP contact and also for fluctuations in the load's energy consumption.

According to a further embodiment, the device is designed as a device external to the charging station. This allows the device to be connected to any charging station. Advantageously, the device has a connection socket, which is embodied to correspond to a charging plug of the charging station in order to contact at least some of the electrical connections available at the charging station. The connection socket of the device is preferably configured to electrically contact the CP contact and the protective conductor of the charging plug.

According to a further exemplary embodiment, the current limiter is configured to maintain a potential between the CP contact and the protective conductor in a range higher than +9 V. This measure ensures that the charging station remains in standby mode and is not activated by the connected load to provide electrical energy via the AC contacts.

### BRIEF DESCRIPTION OF THE SEVERAL VIEWS OF THE DRAWINGS

The disclosure is illustrated schematically in the drawings by means of embodiments and will be further described with reference to the drawings. In the drawings:

The FIGURE shows a schematic connection diagram of an arrangement according to an exemplary embodiment of the disclosure.

Elements and components with the same or similar design or functional features are provided with the same reference numerals.

### DETAILED DESCRIPTION

The FIGURE shows a schematic connection diagram of an arrangement 100 according to an exemplary embodiment of the disclosure. The arrangement 100 has a device 10 and a charging station 20 with at least one charging plug 21. Device 10 is configured to receive electrical energy via a CP contact CP and a circuit breaker PE of charging station 20.

Device 10 has a connection socket 11, which is embodied to correspond to charging plug 21 of charging station 20 in order to contact at least some of the electrical connections available at charging station 20. In the exemplary embodiment illustrated, CP contact CP and protective conductor PE of charging plug 21 are electrically contacted by connecting charging plug 21 to connection socket 11.

In standby mode of charging station 20, +12 V is present between CP contact CP and protective conductor PE. This voltage is used to electrically supply at least one load 12 of device 10. The 12 V voltage is output to device 10 via a 1 kOhm resistor R1 via CP contact CP the protective conductor PE. Resistor R1 can be used, for example, to limit a current.

Device 10 and/or load 12 are arranged outside charging station 20 or are formed externally.

Load 12 can be designed, for example, as a printed circuit board for evaluating and/or collecting data, as an output unit, as a communication interface and the like.

Device 10 has a current limiter 13 connected between CP contact CP of charging station 20 and load 12. Current limiter 13 can be configured in a technically simple manner in the form of a series resistor. Alternatively, current limiter 13 can be configured as an electronic circuit that prevents a specific limit value for the current of electrical load 12 from being exceeded. The limit value for the current is set in such a way that connected load 12 of device 10 does not exit an activated standby mode of charging station 20. This is achieved, for example, by ensuring that the potential provided by CP contact CP does not fall below +9 V across connected device 20. In this case, charging station 20 performs a voltage measurement Va of the potential between CP contact CP and protective conductor PE in order to register a possible voltage drop and, if necessary, exit the standby mode of charging station 20.

Furthermore, a voltage converter 14 is connected, by way of example, between current limiter 13 and load 12 to enable a stable voltage supply for load 12. Device 10 also has an electrical storage device 15 in the form of a battery to absorb power peaks of load 12 via electrical storage device 15 connected in parallel. In this case, electrical storage device 15 can be connected in parallel with load 12 and/or with voltage converter 14.

German patent application no. 102024117379.3, filed Jun. 20, 2024, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A device configured to receive electrical energy from a Control Pilot (CP) contact of a charging plug of a charging station, the device comprising:
at least one load that, in operation, is supplied with the electrical energy from the CP contact of the charging plug of the charging station; and
a current limiter connected between the CP contact of the charging plug of the charging station and the load,
wherein the at least one load, in operation, is supplied with the electrical energy from the charging station in a standby mode of the charging station via the current limiter.

2. The device according to claim 1, wherein the current limiter, in operation, limits a current drawn from the CP contact of the charging plug of the charging station such that a voltage drop of a potential between the CP contact of the charging station and a protective conductor of the charging plug of the charging station is less than 3 V.

3. The device according to claim 1, further comprising:
a voltage converter or a step-up converter connected downstream of the current limiter and upstream of the load.

4. The device according to claim 1, further comprising:
an electrical storage device that includes a rechargeable battery and/or a capacitor.

5. An arrangement, comprising:
a charging station that includes at least one charging plug having a Control Pilot (CP) contact and a protective conductor; and
a device that, in operation, receives electrical energy from the CP contact of the charging plug of the charging station,
wherein the device includes:
at least one load that, in operation, is supplied with the electrical energy from the CP contact of the charging plug of the charging station; and
a current limiter connected between the CP contact of the charging plug of the charging station and the load,
wherein the device, in operation, is electrically connected to the device via the CP contact and the protective conductor of the charging plug of the charging station,
wherein the at least one load of the device, in operation, is supplied with the electrical energy from the charging station in a standby mode of the charging station via the current limiter of the device.

6. The arrangement according to claim 5, wherein the device is external to the charging station.

7. The arrangement according to claim 5, wherein the current limiter of the device, in operation, maintains a potential between the CP contact of the charging station and the protective conductor of the charging station in a range higher than +9 V.
